(19) United States
(12) Patent Application Publication
(10) Pub. No.: US 2013/0318877 A1
(43) Pub. Date: Dec. 5, 2013

(54) Sliding Cantilever Gate

(71) Applicant: Austin Lew Dalman, Baldur (CA)

(72) Inventor: Austin Lew Dalman, Baldur (CA)

(21) Appl. No.: 13/485,375

(22) Filed: May 31, 2012

(51) Int. Cl. E06B 3/46; E05F 11/02; E05F 15/06

(52) U.S. Cl. 49/358

(57) ABSTRACT

A sliding cantilevered gates gate panel is carried by posts for sliding movement in the plane of the gate opening with each post having inner and outer parallel post members separated by a central opening within which the gate panel is mounted. The gate panel has a longitudinally extending track member, a plurality of upstanding posts connected to and upstanding from the track member and a top rail connected across top ends of the posts forming together a generally rectangular panel. Each post has support rollers for running along the track and a drive assembly at a post drives a sprocket engaging a chain mounted inside the track member.

### BACKGROUND OF THE INVENTION

Sliding cantilevered gates are well known and widely used where there is provided a plurality of posts arranged to be mounted in a row in a plane of a gate opening. A gate panel is carried by the posts for sliding movement in the plane of the gate opening with each post having inner and outer parallel post members separated by a central opening within which the gate panel is mounted and along which the gate can move. The gate panel has a longitudinally extending track member, a plurality of upstanding posts connected to and upstanding from the track member and a top rail connected across top ends of the posts forming together a generally rectangular panel.

Each post has on it at least one support roller for running along the track member to support the track member and the gate panel carried thereon. A drive assembly is mounted at or adjacent one of the posts for driving the track member and the gate panel carried thereon longitudinally.

### SUMMARY OF THE INVENTION

It is one object of the present invention to provide an improved gate of this general type.

According to a first aspect of the invention there is provided a sliding cantilevered gate comprising:

a plurality of posts arranged to be mounted in a row in a plane of a gate opening;

a gate panel carried by the posts for sliding movement in the plane of the gate opening;

the gate panel having a longitudinally extending track member, a plurality of upstanding posts connected to and upstanding from the track member and a top rail connected across top ends of the posts forming together a generally rectangular panel;

the track member including an interior channel and a slot along a front of the track member;

each post having mounted thereon at least one support roller for running along the track member to support the track member and the gate panel carried thereon;

a drive assembly mounted at or adjacent one of the posts for driving the track member and the gate panel carried thereon longitudinally;

wherein the drive assembly includes sprocket projecting from a drive motor outside the track member for engaging a chain mounted inside the track member and extending through a slot into the interior channel of the track member for driving longitudinal movement of the chain.

Preferably the drive assembly includes an idler roller on each side of the sprocket for holding the chain engaged against a face of the sprocket.

Preferably the chain passes over a groove in each of the support rollers to locate the chain in the rack member.

Preferably the chain has ends each of which is fixed to the track member at a respective end of the gate panel.

Preferably the track member provides a rectangular receptacle in the channel for the support rollers where the roller diameter is substantially equal to the height of the receptacle to transfer forces from the gate panel either up or down to hold gate panel level regardless of gate position.

Preferably the receptacle for the rollers provides a roller containment guide which has downward lip to hold the rollers against movement axially of the rollers so as to maintain gate movement direction in line with post regardless of wind or other forces.

Preferably the rollers are formed of a plastics material such as Teflon or similar material.

Preferably the track member is positioned at a height above the ground to be of some protection for hitting the gate by vehicles.

Preferably the track member is positioned at a height above the ground to be able to move the gate through snow banks after a blizzard with very little obstruction to facilitate easy snow removal where the gate was sitting.

Preferably the track member is positioned at a height above the ground so that the posts extend downwardly through the track member.

Preferably the track member comprises a polygonal box section with openings at top and bottom for passage of the posts through the box section.

Preferably the track member comprises a rectangular receptacle mounted in and extending along the polygonal box section for receiving the rollers where the rectangular receptacle is welded into a slot of the polygonal box section with a rear wall of the rectangular receptacle butting against the posts.

Preferably at each post there is provided a pair of support rollers spaced longitudinally of the gate panel and carried on a walking beam extending longitudinally.

Preferably there is provided a weighted skirt over the slot of the channel of the track member so as to keep snow and debris out of the channel when the gate is not in use.

Preferably the gate panel is formed in at least two sections connected end to end with each section including a respective section of the track member and wherein there is provided a stub connecting portion inserted into an end of one section of the track member and projecting therefrom for engaging into an end of the next adjacent section of the track member.

Preferably the track member comprises a box section with openings at top and bottom for passage of the posts through the box section and wherein the stub connecting portion includes an opening at a center for receiving a post and two partial opening at ends for butting against a next adjacent post.

According to a second aspect of the invention there is provided a sliding cantilevered gate comprising:

a plurality of posts arranged to be mounted in a row in a plane of a gate opening;

a gate panel carried by the posts for sliding movement in the plane of the gate opening;

the gate panel having a longitudinally extending track member, a plurality of upstanding posts connected to and upstanding from the track member and a top rail connected across top ends of the posts forming together a generally rectangular panel;

the track member including an interior channel and a slot along a front of the track member;

each post having mounted thereon at least one support roller for running along the track member to support the track member and the gate panel carried thereon;

a drive assembly mounted at or adjacent one of the posts for driving the track member and the gate panel carried thereon longitudinally;

wherein the track member provides a rectangular receptacle in the channel for the support rollers where the roller diameter is substantially equal to the height of the receptacle to transfer forces from the gate panel either up or down to hold gate panel level regardless of gate position;

and wherein the receptacle for the rollers provides a roller containment guide which has downward lip to hold the rollers against movement axially of the rollers so as to maintain gate movement direction in line with post regardless of wind or other forces.

According to a third aspect of the invention there is provided a sliding cantilevered gate comprising:

a plurality of posts arranged to be mounted in a row in a plane of a gate opening;

a gate panel carried by the posts for sliding movement in the plane of the gate opening;

the gate panel having a longitudinally extending track member, a plurality of upstanding posts connected to and upstanding from the track member and a top rail connected across top ends of the posts forming together a generally rectangular panel;

the track member including an interior channel and a slot along a front of the track member;

each post having mounted thereon at least one support roller for running along the track member to support the track member and the gate panel carried thereon;

a drive assembly mounted at or adjacent one of the posts for driving the track member and the gate panel carried thereon longitudinally;

wherein the track member comprises a polygonal box section with openings at top and bottom for passage of the posts through the box section;

wherein the track member comprises a rectangular receptacle mounted in and extending along the polygonal box section for receiving the rollers;

and wherein the rectangular receptacle is welded into a slot of the polygonal box section with a rear wall of the rectangular receptacle butting against the posts.

According to a fourth aspect of the invention there is provided a sliding cantilevered gate comprising:

a plurality of posts arranged to be mounted in a row in a plane of a gate opening;

a gate panel carried by the posts for sliding movement in the plane of the gate opening;

the gate panel having a longitudinally extending track member, a plurality of upstanding posts connected to and upstanding from the track member and a top rail connected across top ends of the posts forming together a generally rectangular panel;

the track member including an interior channel and a slot along a front of the track member;

each post having mounted thereon at least one support roller for running along the track member to support the track member and the gate panel carried thereon;

a drive assembly mounted at or adjacent one of the posts for driving the track member and the gate panel carried thereon longitudinally;

wherein the gate panel is formed in at least two sections connected end to end with each section including a respective section of the track member and wherein there is provided a stub connecting portion inserted into an end of one section of the track member and projecting therefrom for engaging into an end of the next adjacent section of the track member;

and wherein the track member comprises a box section with openings at top and bottom for passage of the posts through the box section and wherein the stub connecting portion includes an opening at a center for receiving a post and two partial opening at ends for butting against a next adjacent post.

### BRIEF DESCRIPTION OF THE DRAWINGS

FIG. 1 is a side elevational view of a gate according to the present invention including a gate panel carried on posts.

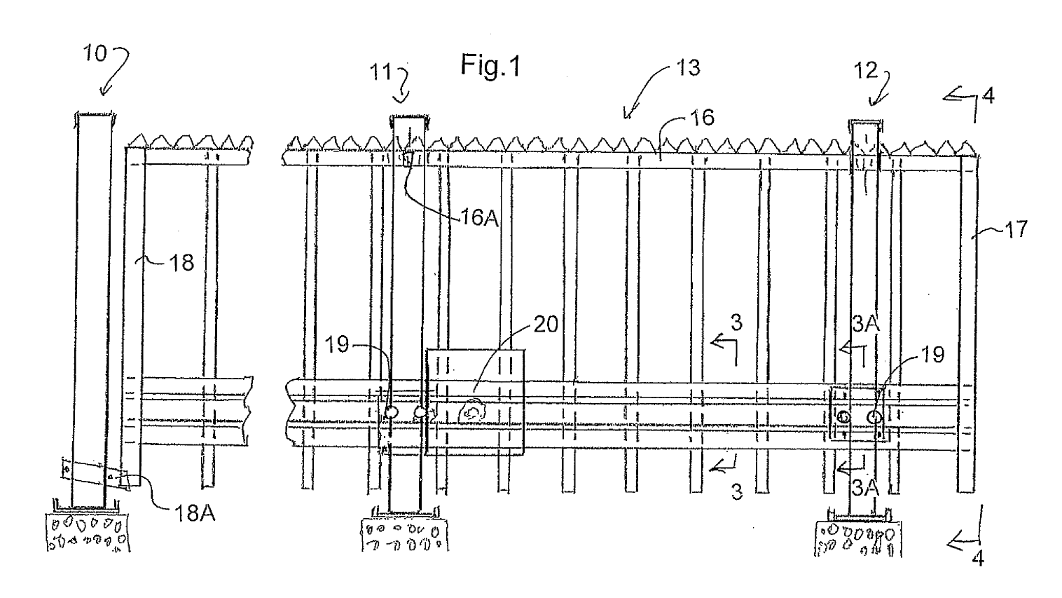

FIG. 2 is a side elevational view of the gate of FIG. 1 with the gate panel omitted showing the drive and support system of the main support channel of the gate panel.

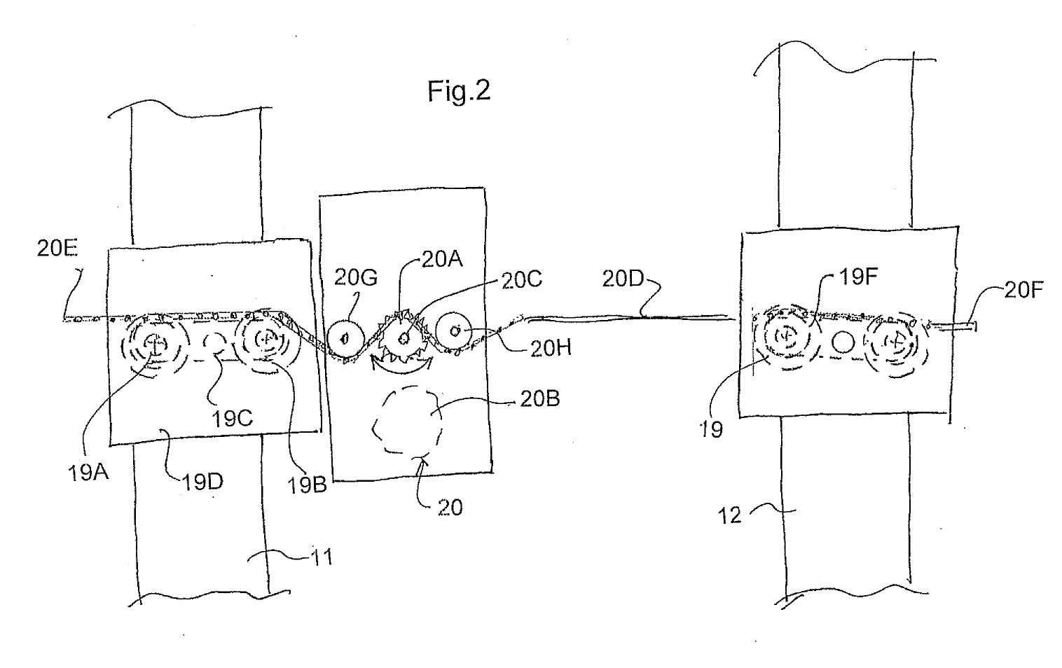

FIG. 3 is a cross-sectional view along the lines 3-3 of FIG. 1.

FIG. 3A is a cross-sectional view along the lines 3A-3A of FIG. 1.

FIG. 4 is an end elevational view of the gate along the lines 4-4 of FIG. 1.

FIG. 5 is an exploded isometric view of the main support rail of the gate panel of the gate of FIG. 1.

### DETAILED DESCRIPTION

The sliding cantilevered gate comprises a plurality of posts 10, 11, 12 arranged to be mounted in a row in a plane of a gate opening. A gate panel 13 is carried by the posts for sliding movement in the plane of the gate opening. Each post has inner and outer parallel post members 12A, 12B separated by a central opening 12C within which the gate panel 13 is mounted and along which the gate panel can move. The gate panel 13 has a longitudinally extending track member 14, a plurality of upstanding posts 15 connected to and upstanding from the track member 14 and a top rail 16 connected across top ends of the posts 15 forming together a generally rectangular panel. The ends of the gate panel is closed by end plates 17 and 18 which is parallel to the end post but is wider than the posts so as to meet and close the end of the track 14.

Each post 11 and 12 has mounted on it at least one support roller 19 for running along the track member 14 to support the track member 14 and the gate panel 13 carried thereon. A drive assembly 20 is mounted at or adjacent one of the posts 11 for driving the track member 14 and the gate panel 13 carried thereon longitudinally.

The track member 14 is positioned at a height above the ground so that the posts 15 extend downwardly through the track member to a position closely adjacent the ground with the track member at a height from the ground to be of some protection for hitting the gate by vehicles. The track member is also positioned at a height above the ground to be able to move the gate through snow banks after a blizzard with very little obstruction to facilitate easy snow removal where the gate was sitting.

The track member 14 comprises a polygonal box section 14A with horizontal top and bottom panels 14B, 14C each having openings 14D for passage of the posts through the box section 14A.

The box section 14A is formed by bending a metal sheet to form the top and bottom panels, rear panel 14E and inclined corner panels 14F. A front panel 14G is open along the center to form a slot 14H with top and bottom vertical flanges 14J, 14K.

The track member 14 further provides a rectangular receptacle 14R for the support rollers 19 with a rear wall 14S, a top wall 14U, a bottom wall 14T and two down-turned flanges 14V and 14W either side of a front opening. The diameter of roller 19 is substantially equal to the height of the receptacle between walls 14U and 14T to transfer forces from the gate panel either up or down to hold gate panel level regardless of gate position.

The receptacle 14R is welded to the box 14A at the bottom of the flange 14J which is welded to the top wall 14U and the top of the flange 14K is welded to the bottom wall 14T at the flange 14W. The receptacle thus provides for the rollers a roller containment guide which has downward lip defined by flange 14V to hold the rollers 19 against movement axially of the rollers so as to maintain gate movement direction in line with post regardless of wind or other forces. The rollers 19 are formed of a plastics material such as Teflon or similar material.

The rectangular receptacle 14R is mounted in and extends along the polygonal box section 14A for receiving the rollers 19 where the rectangular receptacle 14R is welded into the slot 14H of the polygonal box section 14A with the rear wall 14S of the rectangular receptacle butting against the posts 15.

At each post there is provided a pair of support rollers 19A, 19B spaced longitudinally of the gate panel and carried on a walking beam 19C extending longitudinally. The rollers 19 are carried on a plate 19D attached to the inside face of the post portion 12A.

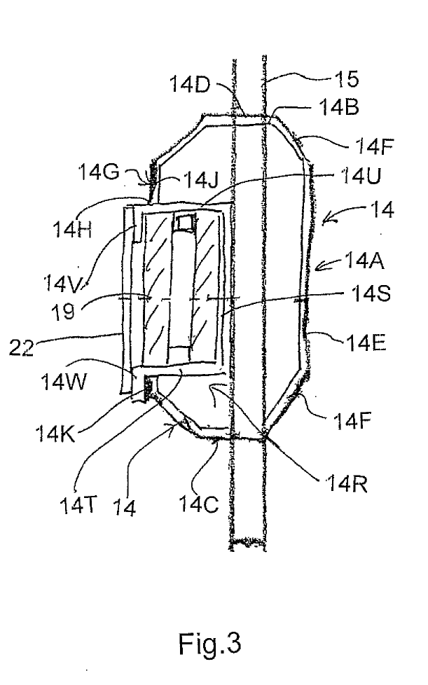

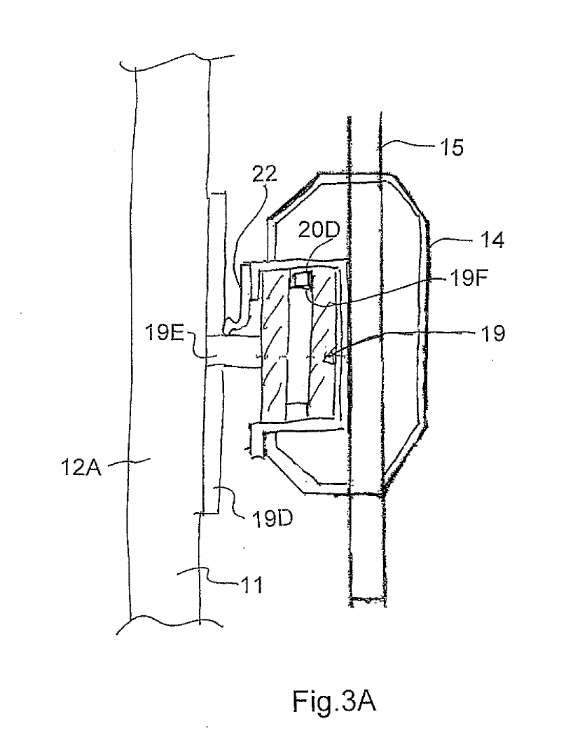

There is provided a weighted skirt 22 over the slot of the channel of the track member so as to keep snow and debris out of the channel when the gate is not in use. The skirt folds up as shown in FIG. 3A as the part of the skirt passes over the shaft 19E of the roller 19.

The drive assembly 20 includes a sprocket 20A projecting from a shaft 20C connected to a drive motor 20B outside the track member 19 for engaging a chain 20D mounted inside the track member 14. The shaft 20B extends through a slot into the interior channel of the track member for driving longitudinal movement of the chain. The chain 20D passes over a groove 19F in each of the support rollers 19 to locate the chain in the track member. The chain has ends 20E and 20F each of which is fixed to the track member 14 at a respective end plate 17, 18 of the gate panel. The drive assembly 20 includes an idler roller 20G, 20H on each side of the sprocket 20A for holding the chain engaged against a face of the sprocket.

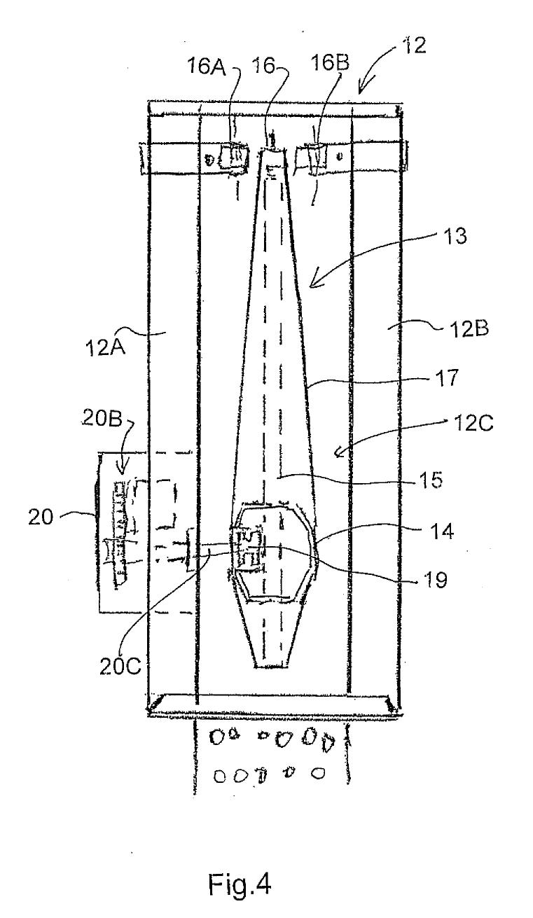

The top rail of the gate panel runs between guide rollers 16A, 16B to locate the rail in side to side position as shown in FIG. 4. The end post 10 includes a locating receptacle 18A which engages and locates the end plate 18 in the closed position of the gate panel.

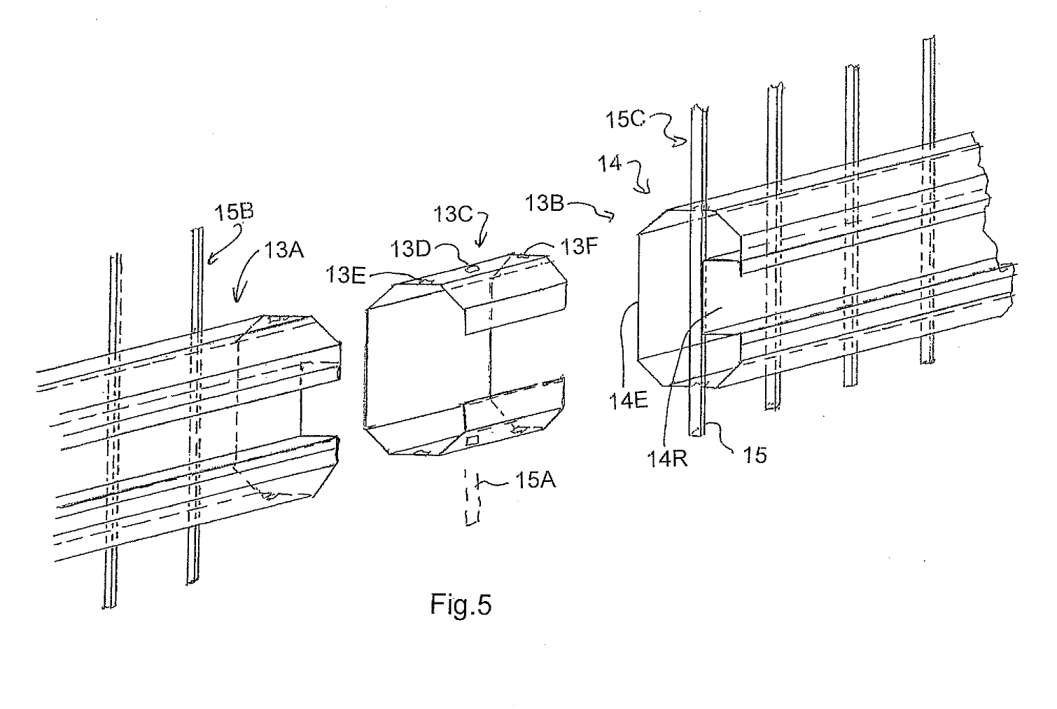

As shown in FIG. 5, the gate panel 13 is formed in at least two sections 13A, 13B connected end to end with each section including a respective section of the track member 14. There is provided a stub connecting portion inserted 13C into an end of one section of the track member 14 and projecting therefrom for engaging into an end of the next adjacent section of the track member. The stub connecting portion is a sliding fit into the interior of the box section 14A and includes an opening 13D at a center for receiving a post 15A and two partial opening 13E and 13F at ends for butting against a next adjacent post 15B, 15C.

1. A sliding cantilevered gate comprising:
a plurality of posts arranged to be mounted in a row in a plane of a gate opening;
a gate panel carried by the posts for sliding movement in the plane of the gate opening;
the gate panel having a longitudinally extending track member, a plurality of upstanding posts connected to and upstanding from the track member and a top rail connected across top ends of the posts forming together a generally rectangular panel;
the track member including an interior channel and a slot along a front of the track member;
each post having mounted thereon at least one support roller for running along the track member to support the track member and the gate panel carried thereon;
a drive assembly mounted at or adjacent one of the posts for driving the track member and the gate panel carried thereon longitudinally;
wherein the drive assembly includes sprocket projecting from a drive motor outside the track member for engaging a chain mounted inside the track member and extending through a slot into the interior channel of the track member for driving longitudinal movement of the chain.

2. The gate according to claim 1 wherein the drive assembly includes an idler roller on each side of the sprocket for holding the chain engaged against a face of the sprocket.

3. The gate according to claim 1 wherein the chain passes over a groove in each of the support rollers to locate the chain in the rack member.

4. The gate according to claim 1 wherein the chain has ends each of which is fixed to the track member at a respective end of the gate panel.

5. The gate according to claim 1 wherein the track member provides a rectangular receptacle in the channel for the support rollers where the roller diameter is substantially equal to the height of the receptacle to transfer forces from the gate panel either up or down to hold gate panel level regardless of gate position.

6. The gate according to claim 1 wherein the receptacle for the rollers provides a roller containment guide which has downward lip to hold the rollers against movement axially of the rollers so as to maintain gate movement direction in line with post regardless of wind or other forces.

7. The gate according to claim 1 wherein the rollers are formed of a plastics material such as Teflon or similar material.

8. The gate according to claim 1 wherein the track member is positioned at a height above the ground to be of some protection for hitting the gate by vehicles.

9. The gate according to claim 1 wherein the track member is positioned at a height above the ground to be able to move the gate through snow banks after a blizzard with very little obstruction to facilitate easy snow removal where the gate was sitting.

10. The gate according to claim 1 wherein the track member is positioned at a height above the ground so that the posts extend downwardly through the track member.

11. The gate according to claim 1 wherein the track member comprises a polygonal box section with openings at top and bottom for passage of the posts through the box section.

12. The gate according to claim 1 wherein the track member comprises a rectangular receptacle mounted in and extending along the polygonal box section for receiving the rollers where the rectangular receptacle is welded into a slot of the polygonal box section with a rear wall of the rectangular receptacle butting against the posts.

13. The gate according to claim 1 wherein at each post there is provided a pair of support rollers spaced longitudinally of the gate panel and carried on a walking beam extending longitudinally.

14. The gate according to claim 1 wherein there is provided a weighted skirt over the slot of the channel of the track member so as to keep snow and debris out of the channel when the gate is not in use.

15. The gate according to claim 1 wherein the gate panel is formed in at least two sections connected end to end with each section including a respective section of the track member and wherein there is provided a stub connecting portion inserted into an end of one section of the track member and projecting therefrom for engaging into an end of the next adjacent section of the track member.

16. The gate according to claim 1 wherein the track member comprises a box section with openings at top and bottom for passage of the posts through the box section and wherein the stub connecting portion includes an opening at a center for receiving a post and two partial opening at ends for butting against a next adjacent post.

17. A sliding cantilevered gate comprising:
a plurality of posts arranged to be mounted in a row in a plane of a gate opening;
a gate panel carried by the posts for sliding movement in the plane of the gate opening;
the gate panel having a longitudinally extending track member, a plurality of upstanding posts connected to and upstanding from the track member and a top rail connected across top ends of the posts forming together a generally rectangular panel;
the track member including an interior channel and a slot along a front of the track member;
each post having mounted thereon at least one support roller for running along the track member to support the track member and the gate panel carried thereon;
a drive assembly mounted at or adjacent one of the posts for driving the track member and the gate panel carried thereon longitudinally;
wherein the track member provides a rectangular receptacle in the channel for the support rollers where the roller diameter is substantially equal to the height of the receptacle to transfer forces from the gate panel either up or down to hold gate panel level regardless of gate position;
and wherein the receptacle for the rollers provides a roller containment guide which has downward lip to hold the rollers against movement axially of the rollers so as to maintain gate movement direction in line with post regardless of wind or other forces.

18. A sliding cantilevered gate comprising:
a plurality of posts arranged to be mounted in a row in a plane of a gate opening;
a gate panel carried by the posts for sliding movement in the plane of the gate opening;
the gate panel having a longitudinally extending track member, a plurality of upstanding posts connected to and upstanding from the track member and a top rail connected across top ends of the posts forming together a generally rectangular panel;
the track member including an interior channel and a slot along a front of the track member;
each post having mounted thereon at least one support roller for running along the track member to support the track member and the gate panel carried thereon;
a drive assembly mounted at or adjacent one of the posts for driving the track member and the gate panel carried thereon longitudinally;
wherein the track member comprises a polygonal box section with openings at top and bottom for passage of the posts through the box section;
wherein the track member comprises a rectangular receptacle mounted in and extending along the polygonal box section for receiving the rollers;
and wherein the rectangular receptacle is welded into a slot of the polygonal box section with a rear wall of the rectangular receptacle butting against the posts.

19. (canceled)
